(19) United States
(12) Patent Application Publication
(10) Pub. No.: US 2013/0257424 A1
(43) Pub. Date: Oct. 3, 2013

(54) MAGNETIC RESONANCE ROCK ANALYSIS

(71) Applicant: SCHLUMBERGER TECHNOLOGY CORPORATION, Sugar Land, TX (US)

(72) Inventors: DANIEL HOLLAND, CAMBRIDGE (GB); JONATHAN MITCHELL, GREAT CAMBOURNE (GB); LYNN GLADDEN, LANDBEACH (GB)

(73) Assignee: Schlumberger Technology Corporation, Sugar Land, TX (US)

(21) Appl. No.: 13/849,268

(22) Filed: Mar. 22, 2013

Related U.S. Application Data
(60) Provisional application No. 61/616,280, filed on Mar. 27, 2012.

(51) Int. Cl. G01N 24/08

(52) U.S. Cl. CPC G01N 24/081
USPC 324/303; 324/309; 324/318

(57) ABSTRACT

Processing is described for magnetic resonance measurements of granular material in the reciprocal Fourier domain to determine grain size distribution and/or pore size distribution in the granular material. In some examples, the granular material is a rock from subterranean reservoir containing water, oil, gas or a combination thereof. The processing of the magnetic resonance data can include a Bayesian analysis and can be used to provide information on length scales below the resolution obtained practicably in conventional magnetic resonance imaging experiments.

### CROSS REFERENCE TO RELATED APPLICATION

This application claims the benefit of U.S. Provisional Patent Application Ser. No. 61/616,280 filed Mar. 27, 2012, which is incorporated herein by reference in its entirety.

### BACKGROUND

This disclosure relates to rock analysis where the rock being analyzed may comprise a core sample removed from a formation, the rock making up a formation, the formation and/or the like. In particular, but not by way of limitation, the present disclosure describes using nuclear magnetic resonance to investigate/determine/analyze properties of the rock.

Knowledge of the physical properties of reservoir rock is critical for understanding and simulating the transport of fluids in oil reservoirs. The in situ properties of reservoirs are assessed using well-logging tools that probe some property of the solid/fluid matrix near the well bore. Well-logging is an important part of oil and gas production, particularly during the exploration of new fields. Logging is performed primarily to assess the fluid content of the pore space in sedimentary rocks. A range of down-hole measurements are available currently, including resistivity, γ-ray, neutron, sonic, dielectric, and magnetic resonance (“MR”). Conventionally, MR logging has been used as a method for probing the fluids in the reservoir, but not for providing information on the rock matrix. Generally, rock lithology is determined in the laboratory from material cored from the reservoir/formation.

Conventional techniques for determining properties of the rock include thin sectioning, scanning electron microscopy (“SEM”), and X-ray micro-tomography (“XMT”). In many cases, the shape and size of the individual grains can be identified using these techniques. In terms of identifying grain size, XMT offers a good solution as it provides three-dimensional (“3D”) images of the matrix from which a grain size distribution can be calculated. However, XMT measurements work only on very small rock samples of volume V˜30 mm³ and XMT is not applicable for down-hole/subterranean rock analysis.

In laboratory-scale MR core analysis, it is usual to study core-plugs with a volume V˜100 cm³ on spectrometers with a magnet strength B0=50 mTesla (“T”) (equivalent to a resonant frequency v₀=2 MHz) for comparability to logging tools (although specialized magnets exist to probe whole cores). Well-logging tools probe a similar volume and operate at frequencies v₀<2 MHz, depending on position in the magnetic field.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

According to some embodiments, a method of analyzing a granular solid material is described. The method includes: making a magnetic resonance measurement on a sample of the granular solid material thereby yielding magnetic resonance data; and directly generating a characterization of grain size (e.g., a grain size distribution) of the granular solid material based on the magnetic resonance data. According to some embodiments, a pore size distribution is generated based on the generated grain size distribution and a computational simulation of particle packing. In some embodiments, the pore size distribution is generated using a Monte Carlo simulation algorithm.

According to some embodiments, the magnetic resonance data is in k-space, and the grain size distribution is generated using Bayesian inference analysis to process the magnetic resonance data. For example, the Bayesian inference analysis can include a signal distribution of the magnetic resonance data in k-space, which is modelled and used to calculate a posterior probability distribution that relates a state of grain size distribution to a set of observations. According to some embodiments, the k-space data is Fourier transformed to obtain an image.

According to some embodiments, the granular solid material is rock from a subterranean rock formation (such as a reservoir containing water, oil, gas or a combination thereof), and the granular solid material is obtain using a core sampling tool deployed in a wellbore while the magnetic resonance measurement is made on the sample in a surface facility. According to some other embodiments, a downhole NMR tool is used to make the magnetic resonance measurements. According to some embodiments, the granular material is limestone and includes micropores of about 1 micron or smaller. According to other embodiments, the granular material is another type of rock, such as sandstone or the like.

According to some embodiments, a system for analyzing a granular solid material (such as rock from a subterranean rock formation) is described. The system includes: magnetic resonance measurement equipment adapted and configured to make magnetic resonance measurements on a sample of the granular solid material thereby yielding magnetic resonance data; and a processing system adapted and configured to generate a characterization of grain size of the granular solid material based on the magnetic resonance data. According to some embodiments, the magnetic resonance equipment is further adapted and configured to be deployed on a tool string (e.g., via a wireline or on a Logging While Drilling (LWD) bottom hole assembly) or on a drillstring (for example as a measurement while drilling tool) in a wellbore penetrating the subterranean rock formation. According to some other embodiments, a core sampling tool is deployed on a tool string or a drill string in a wellbore so as to obtain a core sample that includes the sample of the granular solid material, and the magnetic resonance equipment makes the magnetic resonance measurements on the core sample in a surface facility.

### BRIEF DESCRIPTION OF THE DRAWINGS

The subject disclosure is further described in the detailed description which follows, in reference to the noted plurality of drawings by way of non-limiting examples of embodiments of the subject disclosure, in which like reference numerals represent similar parts throughout the several views of the drawings, and wherein:

FIG. 1-1 is a graph illustrating an example of k-space data acquired for a frequency encoded 1D profile of a water-saturated sandstone, according to some embodiments;

FIG. 1-2 illustrates a result of the Bayesian analysis of the k-space data (grain size distribution) in FIG. 1-1 for the sandstone, along with a Bayesian-MR estimated grain size distribution for the limestone example, according to some embodiments;

FIG. 2 is a graph showing the Bayesian-MR estimated grain size distributions shown in FIG. 1-2, obtained in accordance with some embodiments, overlaid with the grain size distributions from an X-ray micro-tomographic process;

FIGS. 3-1 and 3-2 are graphs showing Bayesian-MR predicted pore radius distributions for sandstone and limestone, according to some embodiments, overlaid with pore radius distributions derived from T₂ relaxation time analysis;

FIG. 4 is a diagram showing aspects of a system for analyzing a granular solid material, according to some embodiments; and

FIG. 5 is a diagram showing aspects of a system for analyzing a granular solid material, according to some other embodiments.

### DETAILED DESCRIPTION

Reference will now be made in detail to some embodiments, examples of which are illustrated in the accompanying drawings and figures. In the following detailed description, numerous specific details are set forth in order to provide a thorough understanding of the subject matter herein. However, it will be apparent to one of ordinary skill in the art that the subject matter may be practiced without these specific details. In other instances, well known methods, procedures, components, and systems have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step. The first object or step, and the second object or step, are both, objects, or steps, respectively, but they are not to be considered the same object or step.

The terminology used in the description of the disclosure herein is for the purpose of describing particular embodiments only and is not intended to be limiting of the subject matter. As used in this description and the appended claims, the singular forms “σᵣ” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

In accordance with certain embodiments, Bayesian magnetic resonance (“MR”) is used for rock type determination either at the laboratory-scale for commercial core analysis, in MR commercial oil well logging and/or MR measurement while drilling. Bayesian analysis of MR data may provide information on length scales below the resolution obtained practicably in conventional MR imaging experiments.

In some embodiments, MR data is acquired in the reciprocal Fourier domain, k-space, of the real (image) space. In such an embodiment, Bayesian-MR is used to act on the k-space data directly and as a result overcomes several limitations associated with obtaining spatially resolved data on general MR instrumentation. In some embodiments, the Bayesian-MR analysis provides a grain size distribution of the rock under study. Once a grain size has been determined, in accordance with some embodiments, a simulation of the grain packing allows a corresponding pore size distribution to be calculated. In certain aspects, the increased level of in situ detail provided by this technique facilitates an improved understanding of structure-transport relationships in oil reservoirs and hence better predictions of oil recovery.

Methods and systems in accordance with some embodiments have commercial implications in laboratory-scale core analysis, in reservoir-scale oil well logging and the like. A laboratory-scale measurement allows a coherent set of MR-determined petrophysical properties to be obtained on the same rock plug, providing data that is representative of heterogeneities on the plug scale, and eliminating issues of data comparison between different experimental techniques. Imaging with a logging tool may follow the concept of stray field imaging (“STRAFI”) by utilizing the magnetic field gradient inherent in any tool design. In some embodiments, the STRAFI limitation that the sample length must be less than the field of view (“FOV”) can be waived because the acquired k-space data is fitted directly using an appropriate Bayesian likelihood function (i.e. the projection of multiple grains whose size distribution is defined uniquely by the mean r̅ and standard deviation (σᵣ).

As such, in some embodiments, grain size distributions (and by extension, pore size distributions) may be obtained in situ from the reservoir. In such cases the rock matrix should be saturated fully with fluids of similar spin density (e.g., oil and water). Using conventional techniques, this level of rock characterization has been possible only through a combination of multiple logging technologies. Access to coherent rock characterization in accordance with some embodiments, can increase the commercial value of MR analysis both in core analysis and well logging, and can provide improved simulations of oil recovery and fluid transport in the reservoir.

In laboratory core analysis, Bayesian-MR in accordance with the present disclosure enables grain and pore size distributions to be obtained as part of a coherent work flow, i.e., from the same sample as used in other MR analysis. This improves over conventional techniques of grain sizing, e.g., scanning electron microscopy (SEM) and X-ray micro-tomography (XMT) as these require very small sub-samples to be extracted from the core/rock being analyzed, which may not represent a large volume of heterogeneous rock.

In well logging, the capability to obtain both a MR relaxation time T₂ distribution and Bayesian-MR grain and pore size distribution, in accordance with some embodiments, provides that a single logging tool may be used to provide data that can be obtained currently only from a combination of multiple logging technologies. This use of a single logging tool removes issues of comparability between measurements obtained via different techniques. In accordance with some embodiments, grain sizes may be used to determine rock types in situ and the extension to Bayesian pore sizing does not suffer any of the limitations in the current method of converting T₂ to pore size. In such cases, the rock should be saturated fully with liquid of consistent spin density (e.g., oil and water), which is a condition met in most oil wells.

In some embodiments, modification of existing well logging tools may be made to accommodate the inhomogeneous permanent magnetic field gradient and applied radio frequency (“rf”) magnetic field. Such modifications may take the form of a physical alteration to the tool design or an extra stage in the data processing. Existing MR acquisition protocols are applicable for use in some embodiments described herein, provided the rf probe bandwidth is sufficient to span the range of k-space required. The Bayesian-MR technique of some embodiments described herein is insensitive to the position of the rock grains and as such can be implemented while the logging tool is in motion.

The Bayesian-MR method in accordance with some embodiments may be applicable to sandstone reservoirs, limestone reservoirs or the like. For limestones, the measurement is not affected by the presence of (small) micropores because the signal from liquid in the micropores is confined to the center of k-space (high k-space) and this may not be used in the data processing.

The Bayesian-MR pore sizing method in accordance with some embodiments is able to probe (large) macropores in limestones, beyond the capability of existing MR T₂ measurements. This may be beneficial since it is these pores that determine the flow properties of the porous network. In all cases, the minimum size of grains/pores that can be probed is determined by the magnetic field gradient strength (magnet geometry) and the obtainable signal-to-noise ratio (“SNR”).

MR logging tools can be categorized as unilateral (or stray field) devices because the magnetic field is projected outside the body of the device, allowing signal to be obtained from a sample that cannot be enclosed by the magnet geometry. A unique feature of unilateral MR magnets is a large, static magnetic field gradient ΔB₀. Although sweet-spots can be engineered into the magnetic field allowing for detection of signal from a homogeneous region in the imposed magnetic field B₀, a field gradient must exist somewhere. Conventionally, this field gradient has been utilized as a method for encoding diffusion giving rise to the so-called “diffusion editing” pulse sequence which allows D−T₂ correlations to be acquired (where D is the self-diffusion coefficient of a liquid).

It is possible to put the gradients in unilateral devices to another use: magnetic resonance imaging (“MRI”). In a MRI experiment, the frequency or phase of a spin is determined by its local magnetic field. If a gradient exists in the imposed magnetic field B₀, then a spin will exhibit a frequency or phase determined by its position in the field. By sampling the entire spin ensemble, the spatial distribution of spin density is obtained, i.e., an image. Stray field imaging (“STRAFI”) is a particular subset of MRI which utilizes the fixed gradients of unilateral devices (or the stray field of a super-conducting magnet).

According to some embodiments, information is extracted from MR data that describes the distribution of grain sizes in a rock. The MR measurement consists of acquiring data in the Fourier (reciprocal) domain of an image, referred to as k-space; which data would normally be Fourier transformed to obtain the spatial information. Conventionally, one k-space datum must be sampled for every pixel in the final image produced by the MR processing.

Therefore, conventional MRI of a 3D structure, such as a rock, with sufficient resolution to identify individual grains would use a very large number (˜10⁸) of measurements, which is prohibitively time consuming and restricts the sample volume. If the sample extends beyond the field of view (“FOV”) of the image, then signal from outside the FOV will be folded back onto the image. This would be prohibitive for conventional MRI using a well-logging tool as the sample (reservoir) extends beyond the volume of interest. According to some embodiments, the data is acquired and processed in k-space, overcoming the limitations that prevent well-logging tools being used for conventional MRI.

According to some embodiments, the inherent large magnetic field gradient of the logging tool enables the acquisition of data at k-space frequencies appropriate for determining grain sizes. Through a Bayesian inference approach, which according to some embodiments is applied directly to 1D k-space data, characteristic grain size distributions for the rock may be determined. As the k-space data is not Fourier transformed, the limitations of sample volume compared to FOV are negated. The only limitations on the sample volume are imposed by the instrumentation geometry.

According to some embodiments, once a grain size distribution has been obtained, a pore size distribution can be estimated using a Monte Carlo simulation (or other appropriate calculation) of a densely packed set of grains whose sizes are selected from an experimentally determined grain size distribution. Embodiments described herein can be used to enable, among other things, logging tools to probe both grain size and pore size in rocks. According to one embodiment, a method is demonstrated herein using example data for a sandstone and limestone acquired on a benchtop MR spectrometer.

Spatial resolution on the typical length scales of particles in heterogeneous materials can be impractical to obtain using MRI. Notwithstanding the foregoing, it is possible to apply concepts of texture analysis in image processing to MRI data in order to extract information on randomly distributed structures. According to some embodiments, the MR signal can be obtained either from a soft solid directly or from a fluid surrounding hard grains.

Using prior knowledge of the likely particle shape (e.g., spherical, elliptical and/or the like), the grain size distribution may be determined via Bayesian analysis. According to some embodiments, the signal distribution of the k-space data may be modelled and used to calculate the posterior probability distribution p(θ|ŷ)∝p(ŷ|θ)p(θ), where p(ŷ|θ) is the likelihood function and p(θ) incorporates prior knowledge. The posterior distribution relates the state of the system θ (i.e., the grain size distribution) to the set of observations ŷ.

Merely by way of example, a technique in accordance with some embodiments is demonstrated using Bentheimer sandstone and Ketton limestone. The sandstone has a consistent gas permeability of κ≈3 μm² and a porosity of φ≈23%, and the limestone has κ≈10 μm² and φ≈25%. A magnetic field strength of B₀=1 Tesla was used to provide good signal-to-noise ratio (“SNR”) for samples of volume V˜300 mm³. As the length-scale of macroscopic heterogeneities is <1 mm in the competent rocks studied, this volume is considered sufficient to provide data that is representative of a much larger volume.

Grain size distributions were determined from XMT images using a pore characterization algorithm. These grain size distributions were based on a sample of 5000 grains for the sandstone and 500 grains for the limestone (proportional to average grain volume). From this data, the grain size distribution of both rocks were predicted/determined to be approximately normal and described by the following:

$$p ( r , \overline{r} , {σ}_{r} ) = \frac{1}{\sqrt{2 {πσ}_{r}}} exp [ - \frac{{( r - \overline{r} )}^{2}}{2 {σ}_{r}^{2}} ] \qquad ( 1 )$$

Therefore, we characterize the distribution of r by modelling it as a normal distribution with a mean radius r̅ and standard deviation σᵣ. The parameters r̅ and σᵣ, together define θ uniquely.

The likelihood function that relates the measured signal S(k) in k-space to θ is obtained, in accordance with aspects of the present invention, by considering how the signal intensity varies given a particular distribution of grain size and shape. The projection of a grain centred on x=θ onto the x-axis is defined by the function h(r, x), where r is the characteristic radius of the grain. If we have a system containing N grains, each located at a different position x^{(c)}, the projection of all N grains will be:

f(x)=Σⱼ₌₁^{N}H(rⱼ,x−xⱼ^{(c)}) (2)

where rⱼ is the size of the j^{th} grain centered on position xⱼ^{(c)}. Defining the Fourier transform of the function h(r, x) as H(r, k), the Fourier transform of eq. (2) will be:

F(k)=Σⱼ₌₁^{N}H(rⱼ,k)exp[−2πikxⱼ^{(c)}]. (3)

From the shift invariance of the Fourier transform, the magnitude of H(r, k) is independent of the position xⱼ^{(c)}. The magnitude of a sum of complex values, each of random phase, is described by the Rayleigh distribution provided the number of values N in the sum is sufficiently large. Since MR measures inherently in the Fourier domain of an image, then:

|S(k)|=|F⁰−(k)−F(k)|

(where F₀(k) is the signal from a bulk liquid sample) and the likelihood function relating signal intensity to the state of the system is given by the Rayleigh distribution

$$P ( \vert S ( k ) \vert ) = \frac{\vert S ( k ) \vert}{2 {σ ( k )}^{2}} exp [ - \frac{{\vert S ( k ) \vert}^{2}}{2 {σ ( k )}^{2}} ] \qquad ( 4 )$$

where σ(k)²=E(|S(k)|²)/2 and is obtained from eq. (3). For normal distributions with σᵣ< r̅/2, numerical results show that the Rayleigh distribution holds for experimental values of N≧6, and therefore will be applicable to any useful volume of rock. Merely by way of example, assuming the grains are spherical and their size distribution is given by a δ-function, then an analytic expression for the signal exists. However, for realistic distributions of grain size, a numerical approach may be used whereby the model signal is obtained from Monte-Carlo simulations. In accordance with some embodiments, the Bayesian results are found in practice to be largely insensitive to the choice of particle shape, e.g., ovoids (using an additional parameter of orientation in the model) instead of spheres and/or the like.

In the examples presented here, a simple uninformative prior was used comprising 50 discrete values in the range r̅=10-1000 μm with the probability of each parameter assumed to be equal. Likelihood functions for r̅were generated, each with 15 values of σᵣ in the range σᵣ=5-70 μm. The posterior was calculated for each of the likelihood functions and the grain size distribution estimated from the mean of the posterior distribution. The uncertainty in the measured grain size may be calculated from the standard deviation of the posterior distribution.

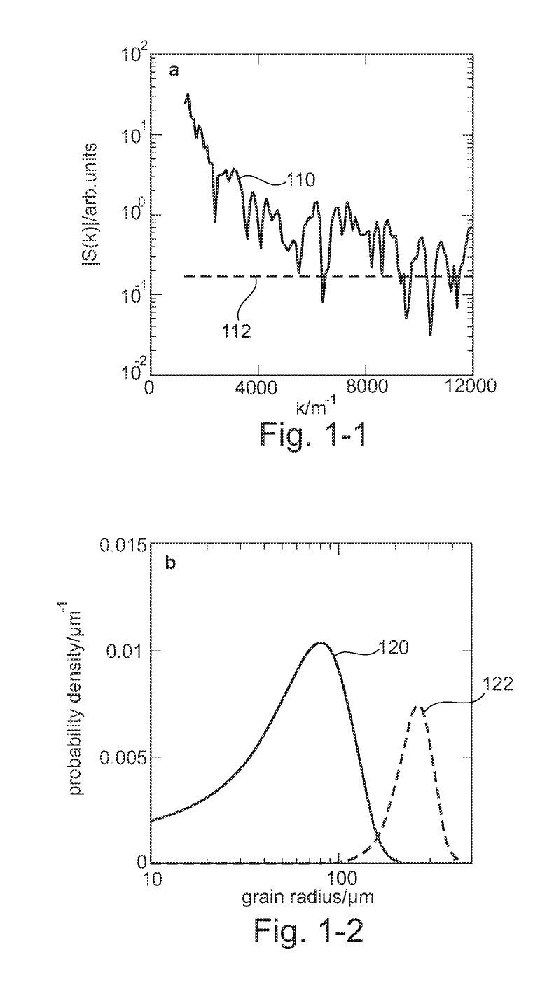

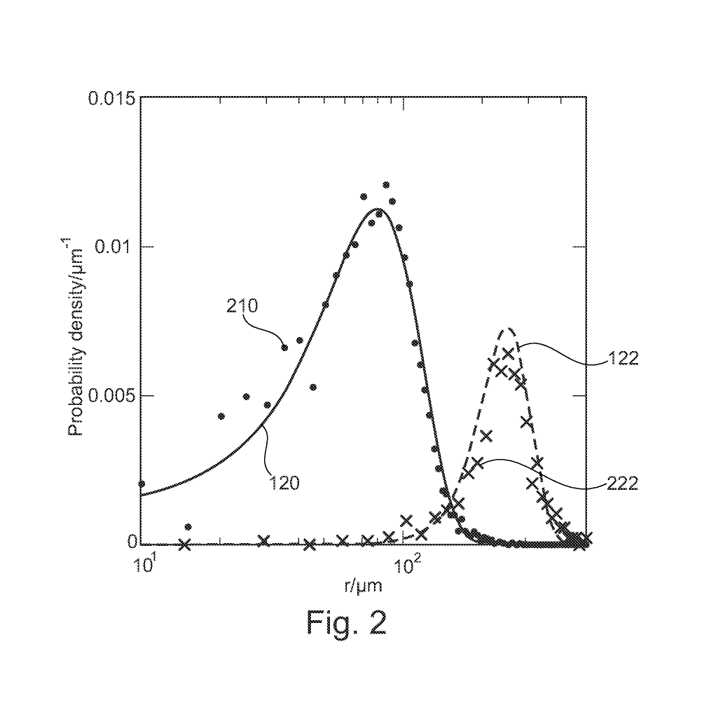

FIG. 1-1 is a graph illustrating an example of k-space data acquired for a frequency encoded 1D profile of a water-saturated sandstone, according to some embodiments. The k-space data, |S(k)|, is shown with line 110 from the sample of a water saturated (Bentheimer) sandstone. The signal is seen to decrease in magnitude with increasing spatial frequency k. The fluctuations in the signal appear to be noise; however, this is not the case. Instead these fluctuations correspond to the phase interference illustrated in eq. (3). To confirm the fluctuation is significant, the noise floor is shown by the dashed line 112. The signal is seen to be comparable to the noise only for k≧10⁴ m⁻¹. Similar results were obtained for the limestone. FIG. 1-2 illustrates a result of the Bayesian analysis of the k-space data in FIG. 1-1 for the sandstone (line 120), along with a Bayesian-MR estimated grain size distribution for the limestone example (line 122), according to some embodiments.

FIG. 2 is a graph showing the Bayesian-MR estimated grain size distributions shown in FIG. 1-2, obtained in accordance with some embodiments, overlaid with the grain size distributions from an X-ray micro-tomographic (XMT) process. The XMT data for the sandstone is shown with dots (such as dot 210), and for the limestone with crosses (such as cross 222). The grain size distributions extracted from the XMT data are normally distributed with mean grain radius r̅=79 μm and standard deviation σᵣ=36 μm for the sandstone, and r̅=255 μm and σᵣ=69 μm for the limestone. The Bayesian-MR grain size distributions are in excellent agreement with those obtained from the XMT data.

These results illustrate that the Bayesian analysis technique in accordance with some embodiments as described herein enable high resolution measurements using low field permanent magnets. The Bayesian-MR method, in accordance with some embodiments, has numerous advantages over conventional microscopy techniques of grain sizing. Notably, MR is a non-invasive measurement, unlike SEM that requires the rock to be fractured to reveal the grain structure. The Bayesian-MR analysis is faster than XMT measurements (˜1 hour compared to 8 hours). The presence of microporosity does not interfere with the Bayesian analysis as signal from the small pores is obtained at very high k, and not in the portion of k-space used in the Bayesian analysis. The Bayesian-MR method, in accordance with some embodiments, may be applicable to grain sizes r≧10 μm. In the laboratory, it can be applied to the same rock plug as used in other MR core analysis, e.g., flow measurements or oil recovery studies, which is particularly valuable in determining structure-transport relationships in these porous media.

In general, the fundamental MR measurement in the petroleum industry is a transverse T₂ relaxation time distribution as this is generally the only parameter that can be probed readily downhole with moving tools. More complicated measurements, such as diffusion-relaxation correlations can be obtained with slow moving or stationary tools, typically in cased wells. If a single liquid saturates the rock, the T₂ relaxation time is related to the pore body surface-to-volume ratio (“S/V”) by:

$$\frac{1}{{T}_{2}} = \frac{1}{{T}_{2 , b}} + {ρ}_{2} \frac{S}{V} \qquad ( 5 )$$

where 1/T_{2,b} is the bulk liquid relaxation time and ρ₂ is a tunable surface relaxivity parameter. As ρ₂ can vary, even in materials of a similar chemical composition, rescaling T₂ to pore size p≈V/S is not readily quantitative. Addressing this issue is an ongoing challenge in core analysis using existing techniques. For example, limestones exhibit a ρ₂=1-3 μms⁻¹. As such, the industry standard for limestones is “unit-normalization” of T₂ to p by assuming ρ₂=1 μms⁻¹. Sandstones can have a ρ₂ of an order of magnitude larger and an accurate determination of ρ₂ is prevented using existing techniques by the inaccuracy of gas adsorption measurements of surface area in these rocks. Even if ρ₂ is calculated through a combination of surface area and T₂, in the existing methods a pore shape must be assumed and in a continuum of pore bodies and throats, determining a valid pore shape can be difficult. The T₂ measurement can also fail to provide sensitivity to pore size where both S/V and ρ₂ become small (as sometimes occurs in limestones). Under such circumstances, the T_{2,b} term in Eq. (5) will dominate and only the bulk liquid relaxation will be observed.

Conventional pore size distributions are obtained by mercury intrusion porosimetry (“MIP”). MIP is biased to small dimensions as it probes only the minimum radius (so-called “pore throat”) experienced by mercury entering a pore. Moreover, it is known that MIP and T₂ analysis of rock structure probe different aspects of the pore.

Once a grain size distribution has been obtained from Bayesian-MR analysis, in accordance with some embodiments, it can be used to predict a corresponding pore size distribution. In some embodiments, a Monte-Carlo approach may be used to determine the pore size distribution. In some embodiments, by simulating a two-dimensional (“2D”) close-packed cluster of three grains with random size (chosen based on the grain radius probability distribution, for example as shown in FIG. 1-2) a characteristic length-scale (considered equivalent to a radius) p may be calculated for the interstice between the circular projection of the spheres, as the interstice of area A can be approximated by an equilateral triangle, p≈\sqrt{A/2}.

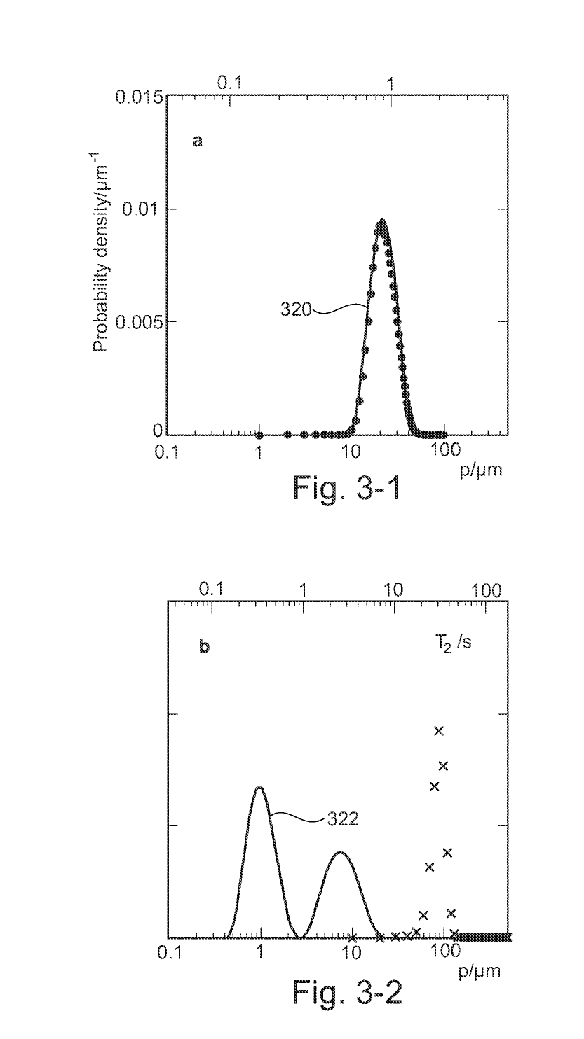

More complicated arrangements of four or more grains may be simulated, although given the compact nature of the rocks, a system with maximum packing efficiency is found to be appropriate in some embodiments. In some embodiments, if an unconsolidated granular solid or a liquid is being analyzed, less efficient packing models may be used. In some embodiments, log-normal pore size distributions may be predicted from the measured grain size distribution by generating 10⁶ interstices (examples of such pore size distributions are shown in FIG. 3-1 for a sandstone and FIG. 3-2 for a limestone). For sandstone, the log-mean pore radius is p̅=21 μm, equivalent to the mean throat radius observed by MIP. For limestone, p̅=90 μm, consistent with the large pore throats observed by MIP.

FIGS. 3-1 and 3-2 are graphs showing Bayesian-MR predicted pore radius distributions for sandstone and limestone, according to some embodiments. In particular, the Bayesian-MR predicted pore radius distributions are shown by the dots (•), referring to the lower x-axis for sandstone in FIG. 3-1, and by crosses (x), referring to the lower x-axis for limestone in FIG. 3-2. In each case a T₂ distribution has been overlaid. The T₂ distribution for sandstone is shown by solid line 320, referring to the upper x-axis in FIG. 3-1, and the distribution T₂ for limestone is shown by solid line 322, referring to the upper x-axis in FIG. 3-2. In both cases the T₂ data was measured at B₀=48 mT using the Carr-Purcell Meiboom-Gill (CPMG) experiment.

In FIG. 3-1, the Bayesian-MR pore size distribution has been used to calibrate the T₂ relaxation time distribution 320 of the sandstone, yielding ρ₂=8 μms⁻¹. For the limestone with a bimodal distribution 322 in FIG. 3-2, T₂ has been “unit normalized” (ρ₂=1 μms⁻¹). The short T₂≈0.3 seconds component is associated with the microporosity inside the ooilids ( p̅˜1 μm) and the long T₂≈2 seconds component is equivalent to bulk water. The size of the macroscopic pores ( p̅=90 μm) predicted by Bayesian-MR is sufficiently large that Eq. (5) no longer applies: (T_{2,b}<<3 p̅/ρ₂) so only the bulk water relaxation time is observed.

Rescaling of T₂ to pore size is applicable up to p̅≈10 μm in limestones with ρ₂=1 μms⁻¹, so the T₂ measurement alone is insufficient to describe the full range of pore sizes found in this ooilithic rock. However, combined with the Bayesian-MR grain size extrapolation, the entire pore size distribution is elucidated. The resultant bimodal pore size distribution is consistent with the pore throat size distribution as determined by MIP, with the modal MR pore sizes being slightly larger than the equivalent modal MIP pore throat radii as expected. Accurate S/V and hence ρ₂ values can be obtained for limestones through gas adsorption measurements in the laboratory. In core analysis, S/V can be obtained on the same core-plug as used in the Bayesian-MR measurement with a gas-adsorption apparatus modified to accommodate the whole rock plug.

T₂ distributions may be measured and used to determine grain size distributions in rocks (i.e. the reverse of the methods described here). However, the T₂ method has several significant limitations, which are highlighted by the results presented in FIGS. 3-1 and 3-2. In the case of sandstones, a value for ρ₂ must be determined to convert T₂ to S/V and then to grain size. The determination of ρ₂ is not straightforward in sandstones (as explained above) and is difficult to achieve in situ in the oil well. For limestones, the macroporosity cannot be explored by T₂ because of the limiting value of T_{2,b} (and diffusive exchange between microporosity and macroporosity) and hence large granular features will not be detected.

By contrast, in some embodiments, the Bayesian-MR method does not suffer from the limitations of the existing T₂ method; in the Bayesian-MR method, the measurement of grain size in sandstones is independent of any surface relaxivity term, and large grains in limestones can be detected readily. Additionally, the T₂ to pore size conversion requires a single saturating fluid to be present, whereas the Bayesian-MR approach does not. However, the Bayesian-MR grain/pore size measurement, in accordance with some embodiments, does require the rock to be fully saturated with fluids of similar spin density. This requirement will be met in most oil/brine reservoirs, although the presence of (undissolved) gas may complicate the interpretation. The measurement of large pores in limestones is of particular importance as these determine the dominant flow and transport characteristics, and hence oil recovery, in the reservoir.

In the later 1980s, early 1990s, STRAFI was one of the first techniques to routinely and reliably provide profiles and images of solids. The stable, high magnetic field gradient found in the fringe fields of conventional super-conducting MR spectroscopy or imaging magnets is sufficient to overcome the broad line-widths of the solid materials. The same concept applies to the permanent magnets of MR logging tools. The gradient is far greater than could be reliably generated inside an imaging magnet using pulsed field gradient technology at that time. STRAFI typically allowed samples to be profiled with a resolution on the order of a few microns to a few tens of microns. STRAFI was (and is) used as a materials characterization tool to study samples ranging from soils to dental resins.

STRAFI relies on obtaining spatially localized MR signals. A finite radio frequency (rf) pulse has insufficient frequency bandwidth, Δωₚ, to excite nuclei across the full length of a sample in a large gradient. Rather, nuclei within a slice—the so-called STRAFI plane zₛ of thickness Δr—are excited selectively. The spatial resolution is given by

$$Δ r = \frac{{Δω}_{p}}{{γ}^{G}} \qquad ( 6 )$$

where γ is the gyromagnetic ratio of the nucleus being investigated and G is the gradient of the magnetic field in the direction parallel to the main polarizing field, B₀ (typically the z-direction, with values of G=20-50 Tm⁻¹ for logging tools). If the required sample thickness L is less than Δr, it is possible to acquire an echo in the normal fashion with G as the read gradient during data acquisition and follow this by the Fourier transform of the data to provide the profile through the sample layer. The method became known as FT-STRAFI. As Bayesian-MR in accordance with some embodiments, does not require the k-space data to be Fourier transformed, the limit that L<Δr is not an issue.

Generally, the spatially varying part of the magnetic flux is described by the tensor

$$\underline{G} = [ \begin{matrix}\frac{\partial {B}_{x}}{\partial x} & \frac{\partial {B}_{y}}{\partial x} & \frac{\partial {B}_{z}}{\partial x} \\ \frac{\partial {B}_{x}}{\partial y} & \frac{\partial {B}_{y}}{\partial y} & \frac{\partial {B}_{z}}{\partial y} \\ \frac{\partial {B}_{x}}{\partial z} & \frac{\partial {B}_{y}}{\partial z} & \frac{\partial {B}_{z}}{\partial z}\end{matrix} ] . \qquad ( 7 )$$

This tensor can be superimposed on a main flux component, i.e. the strong magnetic flux component B₀, along the z-direction

B(r)=B₀+G·r (8)

If B₀ is much stronger than the spatial extension of this tensor inside the sample, the limited bandwidth of the MR experiment reduces this tensor to a gradient vector

$$[ \begin{matrix}\frac{\partial {B}_{z}}{\partial x} , & \frac{\partial {B}_{z}}{\partial y} , & \frac{\partial {B}_{z}}{\partial z}\end{matrix} ] ≡ [ \begin{matrix}{G}_{x} , & {G}_{y} , & {G}_{z}\end{matrix} ] ≡ G \qquad ( 9 )$$

because, to a good approximation, the difference between the B₀ field vector with and without this tensor is negligible. Preferably, the G-vector should have constant components that do not vary over the volume of interest, i.e.

$$\frac{( \partial {B}_{z} ( x , y , z ) )}{\partial x} = {G}_{x} = constant . \qquad ( 10 )$$

For the STRAFI method, this has the following consequence: the so-called STRAFI plane, the chosen xy-plane of the experiments at position zS in the stray-field, does not necessarily coincide with the position where the gradient G_{z} is strongest, but where it is most homogeneous over the sample. Ideally this means

$$\frac{( \partial {B}_{z} ( \begin{matrix}x & y & {z}_{S}\end{matrix} ) )}{\partial x} = \frac{( \partial {B}_{z} ( \begin{matrix}x & y & {z}_{S}\end{matrix} ) )}{\partial y} = 0. \qquad ( 11 )$$

The symmetry of the field is determined by the magnet arrangement and has to obey

∇×B=0, (12)

in the absence of further flux sources. Therefore, the condition in eq. (11) is strictly fulfilled only in a single plane normal to the main field component; otherwise, the flux has a curvature over a finite volume (See, P. J. McDonald, “Stray field magnetic resonance imaging,” Prog. Nucl. Magn. Reson. Spect., Vol. 30, pp. 69-99, (1997)). Although the radius of this curvature is large (in the order of the size of the permanent magnet) its effect on the gradient homogeneity is not negligible and limits the resolution of the experiment. Nevertheless, typical resolutions on the order of a few microns are still obtainable. As with other STRAFI devices, eq. (10) and eq. (11) should be obeyed to a sufficient extent to allow acquisition of the k-space data. Designs for modified logging tool magnet geometries can be envisioned that obey eq. (10) and eq. (11).

The current acquisition implemented often on a well logging tool is a modified Carr-Purcell Meiboom-Gill (CPMG) spin echo train. As each echo is acquired in the presence of the permanent magnetic field gradient, the k-space data is spatially resolved inherently. Multiple echoes would be summed to improve SNR. The only requirement is that the bandwidth of the rf receiver is sufficient to capture the required range of k-space wavenumbers. The inhomogeneous nature of the rf field may also be a limitation, but this could be altered either by a physical modification to the antenna design or as a pre-processing stage in the data analysis. The SNR obtainable on a logging tool may also be a limiting factor which could be addressed by modifying the magnet geometry or increasing the number of signal averages. The SNR will provide an upper boundary on the range of k-space that can be explored and hence the smallest grain size that can be determined. In normal operation, logging tools move through the oil well and acquire signal continually while in motion. As the Bayesian-MR measurement is sensitive only to the grain size distribution (not the position of individual grains), data can be acquired from a moving tool.

Stationary measurements are also possible (usually in cased wells), and this may be desirable to improve SNR and when examining thin rock layers. According to some embodiments, the grain size distribution can be compared to known results in order to determine the rock type as a function of position in the well. According to some embodiments, the analysis model can be re-defined to improve performance in low signal-to-noise applications by, for example, including the joint probability distribution of the real and imaginary channels.

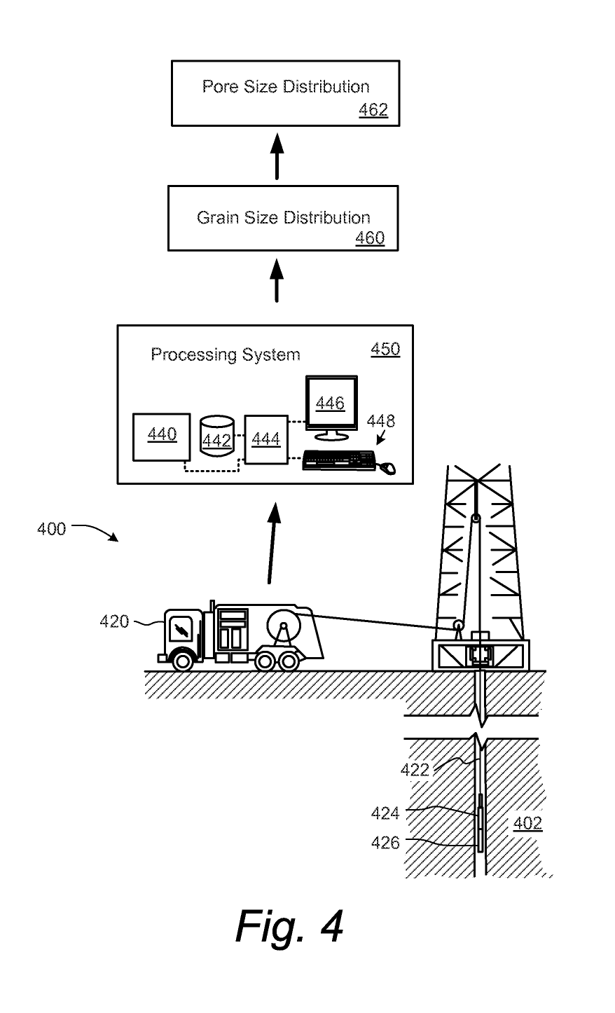

FIG. 4 is a diagram showing aspects of a system for analyzing a granular solid material, according to some embodiments. NMR data is being gathered from a subterranean rock formation 402. A wireline tool string 426 is being deployed in a wellbore via wireline 422 and wireline truck 420 at wellsite 400. The tool string includes one or more wireline tools including an NMR tool 424. The NMR tool 424 acquires MR data which is stored in the wireline truck 420. Processing system 450, which may be located within truck 420 one or more central processing units 444 for carrying out the data processing procedures as described herein, as well as other processing. Processing system, according to some embodiments, also includes a data storage system 442, communications and input/output modules 440, a user display 446 and a user input system 448. According to some embodiments, some or all of processing system 450 may be located in a location remote from the wellsite 400. According to some other embodiments, some or all of the processing system 450 can also be located downhole within the tool string 426. Processing system 450 is adapted and configured to carry out the various processing steps as described herein. For example, according to some embodiments the processing system 450 will generate a grain size distribution 460, and in some embodiments also a pore size distribution 462.

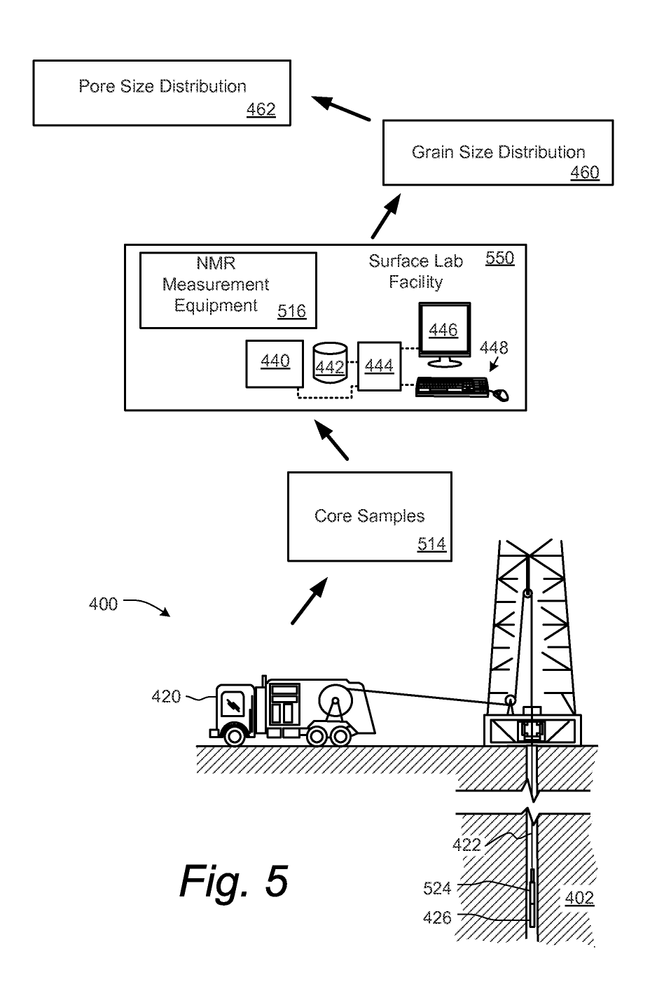

FIG. 5 is a diagram showing aspects of a system for analyzing a granular solid material, according to some other embodiments. In the case of FIG. 5, core samples are being gathered from a subterranean rock formation 402 at wellsite 400 via a wireline truck 420. In this case, wireline toolstring 426 includes a core sampling tool 524. The acquired core sample 514 is transported from the wellsite 400 to a surface facility 550, which includes one or more central processing units 444 for carrying out the data processing procedures as described herein, as well as other processing. Surface facility 550 also includes preparation and measurement equipment 516 which is adapted and configured to carry out the MR measurement procedures such as described herein. According to some embodiment, the surface facility 550 is in a location remote from the wellsite 400, and according to other embodiments, the facility 550 can be located at the wellsite 400. As in the case of FIG. 4, the processing systems in facility 550 are adapted and configured to carry out the various processing steps as described herein, including generating a grain size distribution 460, and in some embodiments also a pore size distribution 462.

According to some embodiments, a well logging tool/measurement while drilling tool for use in a wellbore is described. The tool includes a magnetic resonance system; and a processor configured to process magnetic resonance data from the magnetic resonance system in the reciprocal Fourier domain to determine a grain size distribution of rock surrounding the wellbore.

According to some embodiments, the magnetic resonance system can be modified to provide the required magnetic field strength and field profile for downhole measurements. According to some other embodiments, the rf frequency of the magnetic resonance system can be altered to acquire signal from different positions in the stray magnetic field and hence different depths into the wall of the wellbore.

According to some embodiments, the Bayesian modelling techniques described herein are applied to other, non-MR measurements for purposes of determining rock sample properties. For example, according to some embodiments, the Bayesian modelling techniques described herein are equally applicable to X-ray absorption measurement data from a rock sample through the use of the projection-slice theorem. In this case, the Bayesian technique could be used to generate parameters such as grain size, pore size, the others.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method of analyzing a granular solid material, the method comprising:
making a magnetic resonance measurement on a sample of the granular solid material thereby yielding magnetic resonance data; and
directly generating a characterization of grain size of the granular solid material based at least in part on the magnetic resonance data.

2. The method according to claim 1, wherein the characterization of grain size is a grain size distribution for the granular solid material.

3. The method according to claim 2, further comprising generating a pore size distribution based at least in part on the generated grain size distribution and a computational simulation of particle packing.

4. The method according to claim 3, wherein the generating of the pore size distribution makes use of a Monte Carlo simulation algorithm.

5. The method according to claim 1, wherein the magnetic resonance data is in k-space.

6. The method according to claim 5, wherein the generating of the characterization of grain size uses a Bayesian inference analysis to process the magnetic resonance data.

7. The method according to claim 6, wherein the Bayesian inference analysis includes a signal distribution of the magnetic resonance data in k-space which is modelled and used to calculate a posterior probability distribution that relates a state of grain size distribution to a set of observations.

8. The method according to claim 5, wherein the k-space data is Fourier transformed to obtain an image.

9. The method according to claim 1, wherein the granular solid material is rock from a subterranean rock formation.

10. The method according to claim 9, wherein the sample of the granular solid material is obtain using a core sampling tool deployed in a wellbore penetrating the subterranean rock formation, and the magnetic resonance measurement is made on the sample in a surface facility.

11. The method according to claim 9, wherein a downhole NMR tool is used to make the magnetic resonance measurements, the downhole tool being deployed in a wellbore penetrating the subterranean rock formation.

12. The method according to claim 11, wherein magnetic resonance data includes data of multiple nuclear spin echoes which are summed thereby improving signal to noise ratio.

13. The method according to claim 9, wherein the subterranean rock formation is a reservoir containing water, oil, gas or any combination thereof.

14. The method according to claim 9 wherein the sample of granular material is saturated with a liquid or liquids having similar nuclear spin density.

15. The method according to claim 9 wherein the granular material is limestone and includes micropores of about 1 micron or smaller.

16. The method according to claim 3 wherein the granular material is sandstone.

17. The method according to claim 3 wherein the generated pore size distribution is used to calibrate a surface relaxivity from a magnetic resonance relaxation time distribution.

18. A system for analyzing a granular solid material, the system comprising
magnetic resonance measurement equipment adapted and configured to make magnetic resonance measurements on a sample of the granular solid material thereby yielding magnetic resonance data; and
a processing system adapted and configured to generate a characterization of grain size of the granular solid material based at least in part on the magnetic resonance data.

19. The system according to claim 18, wherein the granular solid material is rock from a subterranean rock formation.

20. The system according to claim 19, wherein the magnetic resonance equipment is further adapted and configured to be deployed on a tool string in a wellbore penetrating the subterranean rock formation.

21. The system according to claim 20, wherein the tool string is configured to be deployed on a wireline.

22. The system according to claim 20, wherein the tool string is configured to be deployed on a bottom hole assembly for use during a drilling operation.

23. The system according to claim 20, further comprising a core sampling tool adapted and configured to be deployed on a tool string in a wellbore penetrating the subterranean rock formation so as to obtain a core sample that includes the sample of the granular solid material, wherein the magnetic resonance equipment is further adapted and configured to make the magnetic resonance measurements on the sample of the granular material in a surface facility.

24. The system according to claim 18 wherein the characterization of grain size is a grain size distribution, and the processing system is further adapted and configured to generate a pore size distribution based at least in part on the generated grain size distribution and a computational simulation of particle packing.

25. The system according to claim 18 wherein the magnetic resonance data is in the k-space, and the generating of the characterization of grain size uses a Bayesian inference analysis to process the magnetic resonance data.

26. A method of analyzing a granular solid material, the method comprising:
making a magnetic resonance measurement on a sample of the granular solid material thereby yielding magnetic resonance data; and
using a Bayesian modelling technique on the magnetic resonance data to determine one or more properties of the a granular solid material.

27. The method according to claim 26, wherein the magnetic resonance data is in k-space.

28. The method according to claim 26, wherein the one or more properties of the granular solid material includes a grain size distribution.

29. The method according to claim 28, wherein the one or more properties of the granular solid material further includes a pore size distribution generated at least in part using the grain size distribution.

30. The method according to claim 26, wherein the granular solid material is rock from a subterranean rock formation.

31. The method according to claim 30, wherein the sample of the granular solid material is obtained using a core sampling tool deployed in a wellbore penetrating the subterranean rock formation, and the magnetic resonance measurement is made on the sample in a surface facility.

32. The method according to claim 30, wherein a downhole NMR tool is used to make the magnetic resonance measurements, the downhole tool being deployed in a wellbore penetrating the subterranean rock formation.
